(19) United States
(12) Patent Application Publication
(10) Pub. No.: US 2026/0184599 A1
(43) Pub. Date: Jul. 2, 2026

(54) COMPOSITE FILTERING DEVICE

(71) Applicant: Ningbo Dongchuan Swimming Pool Equipments Co., Ltd., Ningbo (CN)

(72) Inventors: Hu ZHANG, Ningbo (CN); Huaizhong HE, Ningbo (CN)

(21) Appl. No.: 19/433,369

(22) Filed: Dec. 26, 2025

(30) Foreign Application Priority Data
Dec. 30, 2024 (CN) 202423262040.1

(51) Int. Cl. C02F 1/00; C02F 103/42

(52) U.S. Cl. CPC C02F 1/001; C02F 2103/42; C02F 2201/005

(57) ABSTRACT

A composite filtering device is provided, including a tank with an open top, where a cover is connected to an open top of the tank, and a mixing cavity that communicates with an inner cavity of the tank is provided in a lower end of the cover. A water inlet and a water outlet that communicate with the mixing cavity are provided in the cover. A filter tube that extends into the tank and has its upper and lower ends communicating with each other is further connected to the lower end of the cover. The filter tube is filled with a first filter medium, and a second filter medium is contained in the tank. A lower end of the filter tube extends into the second filter medium, and an upper end communicates with the water outlet.

### TECHNICAL FIELD

The present disclosure relates to the technical field of swimming pool filtering devices, and in particular, to a composite filtering device.

### BACKGROUND

Filter sand tanks are widely used in various water purification and circulation systems such as swimming pools, water parks and drinking water pretreatment. Their main operating principle relies on the pressure of a water pump to eliminate tiny pollutants in swimming pool water through filter sand. The filter sand is filled in a cavity of a filter. Generally, a certain amount of quartz sand is placed in the sand tank, usually more than two-thirds of the volume of the sand tank. When the system is operating normally for filtering, the pool water containing suspended pollutant particles is pressed into the filter by the water pump from a water inlet, and tiny pollutants are captured and filtered out by a sand bed. Filtered clear water enters a water system pipeline from a water outlet and then, after sterilization and disinfection, returns to the swimming pool. Such a device using the filter sand as a medium has low filtering accuracy, and after the sand tank filter has been used for a period of time, pollutants accumulated in the sand tank will obstruct and weaken the water flow. At this time, the filter sand needs to be cleaned. Due to the heavy weight of the quartz sand, it is inconvenient to pour out and clean from the tank.

Currently, there are other alternative solutions on the market. For example, the filter sand inside the tank is replaced with filter cotton balls with higher filtering accuracy, which filter the swimming pool water through a plurality of layers of filter cotton balls. Although the filter cotton balls are lighter in weight than the filter sand and are convenient to remove and clean, they are more likely to adhere to pollutants, thereby increasing the frequency of cleaning compared to the filter sand, which adds to the workload from another aspect.

Therefore, in view of the aforementioned various defects of the prior art, the applicants aim to develop a composite filtering device that can not only ensure a stable filtering effect, but also reduce the workload of cleaning and maintenance.

### SUMMARY

To overcome at least one of the aforementioned defects in the prior art, the present disclosure provides a composite filtering device with high filtering accuracy and low frequency of cleaning filtering media, and labor cost saving.

The present disclosure provides a composite filtering device, including a tank with an open top, where a cover is connected to an open top of the tank, a mixing cavity that communicates with an inner cavity of the tank is provided in a lower end of the cover, a water inlet and a water outlet that communicate with the mixing cavity are provided in the cover, a filter tube that extends into the tank and has its upper and lower ends communicating with each other is further connected to the lower end of the cover, the filter tube is filled with a first filter medium, a second filter medium is contained in the tank, a lower end of the filter tube extends into the second filter medium, and an upper end communicates with the water outlet.

Compared with the prior art, the composite filtering device according to the present disclosure has the following advantages:

The composite filtering device according to the present disclosure includes two-stage filtration, in which the second filter medium is contained in the inner cavity of the tank as primary filtration, and the filter tube is filled with the first filter medium as secondary filtration, with the lower end of the filter tube extending into the second filter medium. During use, swimming pool water is pumped under the pressure of a water pump from the water inlet into the inner cavity of the tank through the mixing cavity, and the second filter medium in the tank performs primary filtration on the swimming pool water. The filtered water then passes through the filter tube again, where the first filter medium performs the secondary filtration, and finally, the filtered water is discharged from the water outlet and then returns to a swimming pool after corresponding sterilization and disinfection. In this structure, two filtering structures are arranged, which effectively improves the filtering accuracy. Furthermore, during cleaning, it is no longer filter cotton balls in the entire thank that need to be cleaned, but only a small amount of the first filter medium in the filter tube, which shortens the cleaning time and does not occupy too much time. In addition, due to the arrangement of double filtration, the frequency of cleaning the second filter medium in the primary filtration is also reduced appropriately, which can further reduce the workload.

As an improvement, a first filter screen cover is connected to the lower end of the filter tube, and a lower end of the first filter screen cover is inserted and positioned at the bottom of the tank. In the aforementioned improved structure, the first filter screen cover can further block large particle pollutants from entering the filter tube, thereby reducing the frequency of cleaning the filter cotton balls.

As a further improvement, a funnel-shaped first connector is arranged at an upper end of a first filter screen cover, and a first positioning insertion tube is arranged at an upper end of the first connector; an inverted funnel-shaped second connector that communicates with the water outlet is provided at the lower end of the cover, a second positioning insertion tube is arranged at a lower end of the second connector, and the upper end and the lower end of the filter tube are detachably inserted and matched within the second positioning insertion tube and the first positioning insertion tube respectively.

As a further improvement, a second filter screen cover accommodated within the tank is connected to the lower end of the cover, an upper open top of the second filter screen cover is connected to a lower open top of the mixing cavity, the bottom of the second filter screen cover is provided with an insertion hole, and an upper end of the second connector is inserted into the insertion hole. In the aforementioned improved structure, the second filter screen cover performs primarily filtration before the swimming pool water enters the tank, thereby improving the filtering accuracy and reducing the frequency of cleaning filter sand.

As a further improvement, the first filter medium is filter cotton balls, and the second filter medium is filter sand; and a backwash inlet that communicates with the mixing cavity is provided in a side wall of the cover, a valve assembly for switching between a filter channel and a backwash channel is provided in the mixing cavity, and when the valve assembly is adjusted to place the backwash channel in communication with the mixing cavity, flushing water is able to enter the mixing cavity from the backwash inlet, and then sequentially pass through the filter tube and the inner cavity of the tank before flowing out from the water inlet. In the aforementioned improved structure, flexible switching between the filter channel and the backwash channel is achieved through the valve assembly. The backwash mode can achieve cleaning of the filter sand without the need to pour it for cleaning, thereby saving time and effort.

In addition, the present disclosure provides a composite filtering device with another structure, including a tank with an open top, where a cover is connected to an open top of the tank, a mixing cavity that communicates with an inner cavity of the tank is provided in a lower end of the cover, the cover is provided with a water inlet and a water outlet that communicate with the mixing cavity, a second filter medium is contained in the tank, a drainage pipe is arranged in the tank, a lower end of the drainage pipe extends into the second filter medium, and an upper end communicates with an inner end of the water outlet; and an outer end of the water outlet is connected to a filter tube, and the filter tube is filled with a first filter medium.

As a further improvement, a first filter screen cover is connected to the lower end of the drainage pipe, and a lower end of the first filter screen cover is inserted and positioned at the bottom of the tank; and a second filter screen cover accommodated within the tank is connected to the lower end of the cover, an upper open top of the second filter screen cover is connected to a lower open top of the mixing cavity, the bottom of the second filter screen cover is provided with an insertion hole, and an upper end of the drainage pipe is inserted into the insertion hole.

As a further improvement, the first filter medium is filter cotton balls, and the second filter medium is filter sand; and a backwash inlet that communicates with the mixing cavity is further provided in a side wall of the cover, a valve assembly for switching between a filter channel and a backwash channel is installed inside the mixing cavity, and when the valve assembly is adjusted to place the backwash channel in communication with the mixing cavity, flushing water is able to enter the mixing cavity from the backwash inlet, pass through the drainage pipe, then enter the inner cavity of the tank, and finally flow out from the water inlet.

Other improved features and advantages of the present disclosure will be described in subsequent specific implementations, and some will become apparent from the specification, or may be learned by practicing the present disclosure. The objectives and other advantages of the present disclosure may be achieved and obtained through the structure particularly pointed out in the specification and the accompanying drawings.

### BRIEF DESCRIPTION OF THE DRAWINGS

FIG. 1 is a three-dimensional structural diagram of Embodiment 1 of a composite filtering device according to the present disclosure.

FIG. 2 is a vertical sectional view of Embodiment 1 of the composite filtering device according to the present disclosure.

FIG. 3 is a vertical sectional view of Embodiment 1 of the composite filtering device according to the present invention from another perspective.

FIG. 4 is an exploded view of a connection structure between a tank and a base in the present disclosure.

FIG. 5 is a sectional view of a structure of Embodiment 2 of a composite filtering device according to the present disclosure.

FIG. 6 is a sectional view of another structure of Embodiment 2 of the composite filtering device according to the present disclosure.

### Descriptions of Reference Signs

1. Tank; 2. Cover; 3. Water inlet; 4. Water outlet; 5. Filter tube; 6. Filter cotton ball; 7. First filter screen cover; 8. First connector; 9. First positioning insertion tube; 10. Second connector; 11. Second positioning insertion tube; 12. Second filter screen cover; 13. Backwash inlet; 14. Valve assembly; 15. Base; 16. Accommodating groove; 17. Positioning insertion hole; 18. Positioning insertion column; 19. Limiting groove; 20. Limiting boss.

### DETAILED DESCRIPTION OF THE EMBODIMENTS

First, it should be understood by those skilled in the art that these implementations are only used to explain the technical principles of embodiments of the present application, and are not intended to limit the protection scope of the present application. Those skilled in the art can make adjustments to the implementations as needed to adapt to specific application scenarios.

In the description of the embodiments of the present application, it should be noted that, unless otherwise clearly specified and limited, the term “fix” or “connection” should be understood in a broad sense. For example, the term may be a fixed connection, a removable connection, or an integral connection; may be a mechanical connection or an electrical connection; or may be a direct connection or an indirect connection through an intermediate medium. For those skilled in the art, the specific meanings of the terms in the embodiments of the present application can be understood based on a specific situation.

The present application is further described in detail below with reference to the accompanying drawings and specific embodiments.

### Embodiment 1

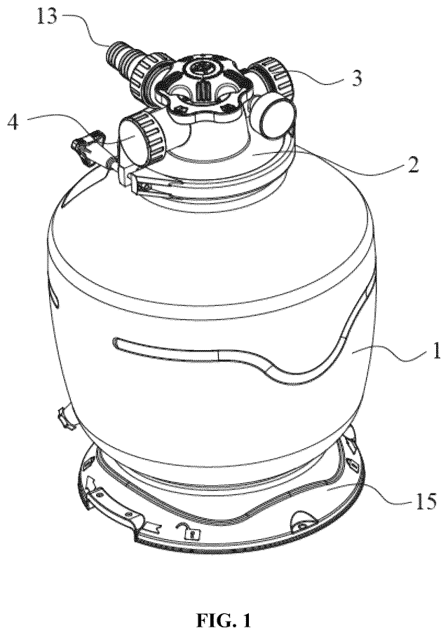

Referring to FIG. 1 to FIG. 4, this embodiment discloses a composite filtering device, including a tank with an open top 1. A cover 2 is detachably connected to an open top of the tank 1 through a hoop, and a mixing cavity that communicates with an inner cavity of the tank 1 is concavely provided in a lower end of the cover 2. A water inlet 3 and a water outlet 4 that communicate with the mixing cavity are provided in a side wall of the cover 2. Specifically, a filter tube 5 that extends downward along the inner cavity of the tank 1 and is provided with communication ports at both ends is also connected to the lower end of the cover 2. That is, the filter tube 5 has its upper and lower ends communicating with each other. The filter tube 5 is filled with a first filter medium. Preferably, the first filter medium is filter cotton balls 6, which are in a fluffy state and fill the volume of the filter tube 5. During filtration, a water pressure causes compression of the filter cotton balls 6, so there is a certain buffer space left inside the filter tube 5 during actual operation. In addition, a second filter medium is contained in the tank 1. Preferably, the second filter medium is filter sand, which usually occupies about two-thirds of the volume of the inner cavity of the tank 1. A lower end of the filter tube 5 extends into the filter sand, and an upper end communicates with the water outlet 4. Further, in this structure, the filtering accuracy of the filter cotton balls 6 is higher than that of the filter sand. The filter sand is used for filtering out pollutants of 0.08 mm and above, and the filtering accuracy of the filter cotton balls 6 reaches 0.04 mm.

In some other embodiments, the first filter medium may also be other types of fibrous filter media such as natural fiber balls or synthetic fiber balls. Since the second filter medium involves backwashing, it may be a granular medium such as coke, activated carbon, or glass slag. Relevant descriptions of the backwashing structure are provided in the following text.

During use, swimming pool water is pumped under the pressure of a water pump from the water inlet 3 into the inner cavity of the tank 1 through the mixing cavity, and the filter sand in the tank 1 performs primary filtration on the swimming pool water. The filtered water then passes through the filter tube 5 again, where the filter cotton balls 6 achieve secondary filtration. Finally, the filtered water is discharged from the water outlet 4 and then returns to a swimming pool again after corresponding sterilization and disinfection. In this structure, two filtering structures are arranged, which effectively improves the filtering accuracy. Furthermore, during cleaning, it is no longer the entire tank 1 of the filter cotton balls that needs to be cleaned, but only a small amount of filter cotton balls 6 in the filter tube 5, which shortens the cleaning time and does not occupy too much time. In addition, due to the arrangement of double filtration, the frequency of cleaning the filter sand in the primary filtration is also reduced appropriately, which can further reduce the workload.

In this embodiment, more specifically, a backwash inlet 13 that communicates with the mixing cavity is also provided in a side wall of a housing, and a valve assembly 14 for switching between a filter channel and a backwash channel is installed inside the mixing cavity. When the valve assembly 14 is adjusted to place the backwash channel in communication with the mixing cavity, flushing water is able to enter the mixing cavity from the backwash inlet 13, and then sequentially pass through the filter tube 5 and the inner cavity of the tank 1 before flowing out from the water inlet 3, thereby achieving backwashing of the filter sand without the need to pour it for cleaning.

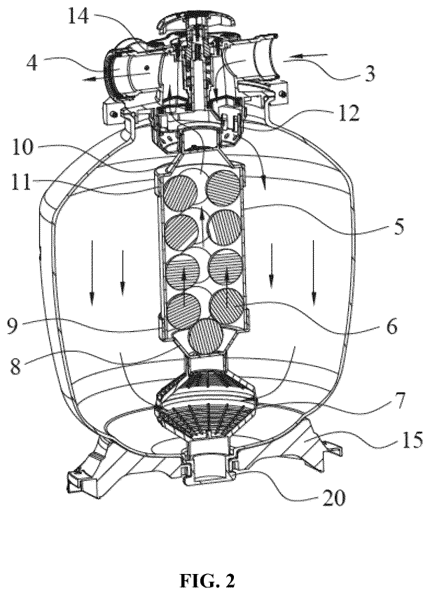

In the aforementioned structure, the filter channel refers to a flow path of the swimming pool water during normal filtration. That is, the swimming pool water enters the mixing cavity from the water inlet 3, flows into the inner cavity of the tank 1, undergoes primary filtration by the filter sand, enters the filter tube 5 from the lower inlet of the filter tube 5 for secondary filtration, and finally flows out from the water outlet 4, as shown in an arrow direction in FIG. 2.

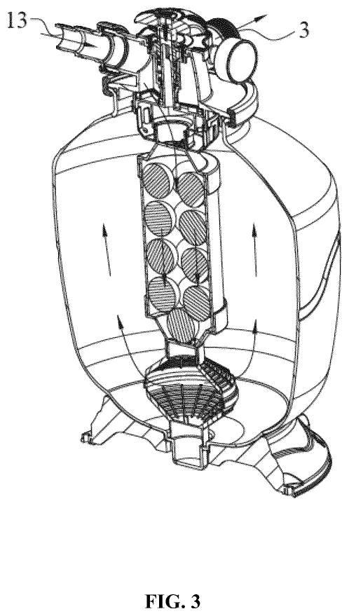

The backwash channel refers to a flow path of flushing water. That is, external flushing water enters a mixer from the backwash inlet 13, then flows through the filter tube 5 into the bottom of the inner cavity of the tank 1, and flows out from the water inlet 3, as shown in an arrow direction in FIG. 3. This channel is mainly used for backwashing the filter sand. Due to poor backwashing effect of the filter cotton balls 6, they still need to be removed for cleaning. However, due to the small quantity and their position in secondary filtration position, the cleaning frequency is not high and they do not take up too much time.

In addition, the valve assembly 14 in the aforementioned structure pertains to the prior art developed by the applicants, and has been granted a patent. For details, reference may be made to the patent No. CN213088908U, which discloses a simple multifunctional valve for a swimming pool filtering device. Channels can be switched very conveniently by pressing and rotating a knob. This structure is not the focus of the present application, and will not be further elaborated herein.

In this embodiment, further, a first filter screen cover 7 is connected to the lower end of the filter tube 5, and a lower end of the first filter screen cover 7 is inserted and positioned at the bottom of the tank 1, thereby improving the filtering effect while also enhancing the structural stability of the filter tube 5.

In this embodiment, the first filter screen cover 7 includes a first cover body and a second cover body that are docked together and are of a conical structure. The first cover body and the second cover body are assembled together at a large-diameter end. A small-diameter end (upper end) of the first cover body is connected to the lower end of the filter tube 5 through a first connecting pipe. A small-diameter end (lower end) of the second cover body is inserted and positioned at the bottom of the tank 1 through a second connecting pipe. In this structure, an upper half and a lower half of the first filter screen cover 7 both are sloped, which ensures that water at the bottom of the tank enters the filter tube 5 smoothly while filtering out large particle impurities.

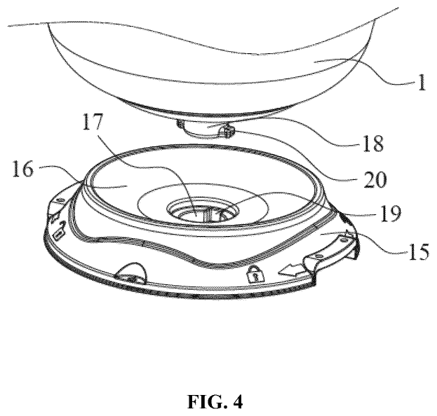

Referring to FIG. 4, in this embodiment, a base 15 is further arranged at the bottom of the tank 1, and an arc-shaped accommodating groove 16 is concavely formed in an upper end surface of the base 15. The bottom of the tank 1 is of an outwardly convex arc-shaped structure, and a positioning insertion hole 17 is provided at the bottom of the accommodating groove 16. A positioning insertion column 18 that is outwardly convex is formed at the bottom of the tank 1, and two inwardly concave limiting grooves 19 are symmetrically provided in an inner wall of the positioning insertion hole 17. Correspondingly, two limiting bosses 20 that cooperate with the limiting grooves 19 are formed on an outer wall of the positioning insertion column 18. During installation, the positioning insertion column 18 at the lower end of the tank 1 is loaded into the positioning insertion hole 17 along the positions of the limiting bosses 20 corresponding to the limiting grooves 19, and then, the base 15 is rotated until upper end surfaces of the limiting bosses 20 abut against a lower end surface of a middle part of the base 15, thereby achieving the installation and fixation of the two components. In this structure, the lower end surface of the middle part of the base 15 is higher than a lower end surface of its periphery.

In the aforementioned structure, a countersunk hole is provided at the bottom of the inner cavity of the tank 1 and extends axially along the positioning insertion column 18 to form an insertion hole. The insertion hole and the positioning insertion column 18 are integrally formed, and the lower end of the first filter screen cover 7 is inserted and fitted in the insertion hole. In this structure, the positioning insertion column 18, which is outwardly convex at the bottom of the tank, not only achieves the insertion and positioning with the base 15, but also achieves the insertion and positioning of the lower end of the first filter screen cover 7. This structure is reasonable and convenient for processing.

In another aspect, in this embodiment, a funnel-shaped first connector 8 is arranged at an upper end of a first filter screen, and a first positioning insertion tube 9 is arranged at an upper end of the first connector 8. An inverted funnel-shaped second connector 10 that communicates with the water outlet 4 is connected to the lower end of the cover 2, and a second positioning insertion tube 11 is arranged at a lower end of the second connector 10. The upper end and the lower end of the filter tube 5 are detachably inserted and matched within the second positioning insertion tube 11 and the first positioning insertion tube 9 respectively. When the filter cotton balls 6 need to be cleaned, the filter tube 5, the first filter screen cover 7, and the second filter screen cover 12 can be removed as a whole after the cover 2 is opened, and then the filter cotton balls 6 can be poured out and cleaned by disassembling the second connector 10, which is very convenient.

In addition, in this structure, due to the presence of the structure of the valve assembly 14, the upper end of the second connector 10 does not need to directly communicate with the water outlet 4, but only needs to communicate with the mixing cavity, and the channels can be switched by operating the valve assembly 14. Specifically, a second filter screen cover 12 accommodated within the tank 1 is connected to the lower end of the cover 2, an upper open end of the second filter screen cover 12 is connected to a lower open top of the mixing cavity, an insertion hole is formed in the bottom of the second filter screen cover 12, and an upper end of the second connector 10 is inserted into the insertion hole. In this structure, the swimming pool water, after entering the mixing cavity from the water inlet 3, first undergoes preliminary filtration by the second filter screen cover 12, and then enters the inner cavity of the tank 1. Preferably, a bottom cover of a water distribution disc of the valve assembly 14 can be directly serve as the second filter screen cover 12. For details, reference may be made to the structure disclosed in the patent No. CN213088908U.

### Embodiment 2

This embodiment is basically the same as Embodiment 1 in structure, with only difference being the specific installation position of the filter tube 5. In Embodiment 1, the filter tube 5 is installed in the tank 1, whereas in this embodiment, the filter tube 5 is installed outside the tank 1, specifically at an outer end of the water outlet 4.

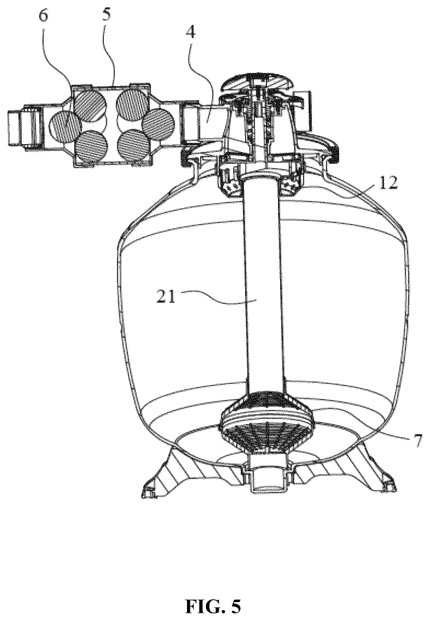

Referring to FIG. 5, the filter tube 5 is directly connected to the outer end of the upper water outlet 4 in the side wall of the cover 2. The filter tube 5 is also filled with filter cotton balls 6, and two funnel-shaped connectors are also inserted at both ends of the filter tube 5.

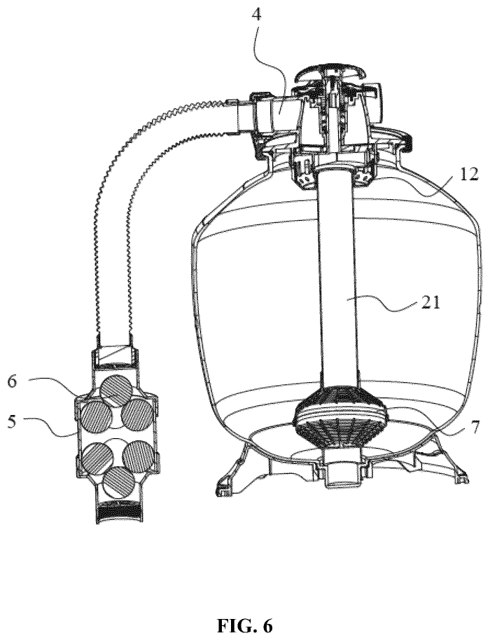

Referring to FIG. 6, the filter tube 5 may also be indirectly connected to the outer end of the upper water outlet 4 in the side wall of the cover 2 through a flexible hose that can be deformed. The filter tube 5 is also filled with filter cotton balls 6, and two funnel-shaped connectors are also inserted at both ends of the filter tube 5.

Regardless of the connection structure, they all serve the function of secondary filtration. That is, the swimming pool water enters the tank 1 and undergoes primary filtration through the filter sand, and then secondary filtration through the filter cotton balls 6 at the water outlet end, thereby effectively improving the filtering accuracy.

In the description of the present application, descriptions with reference to the terms such as “this embodiment” are intended to refer to specific features, mechanisms, materials, or characteristics described in conjunction with the embodiment or example are included in at least one embodiment or example of the present application. In this specification, the illustrative expressions of the above-mentioned terms do not necessarily refer to the same embodiment or example. Moreover, the specific features, mechanisms, materials or characteristics described may be combined in any one or more embodiments or examples in a suitable manner. In addition, without any contradiction, those skilled in the art may bind and combine different embodiments or examples and features of different embodiments or examples that are described in this specification.

The aforementioned descriptions are merely specific implementations of the present application, but the protection scope of the present application is not limited thereto. Any variations or replacements readily figured out by those skilled in the art within the technical scope disclosed in the present application shall fall within the protection scope of the present application. Therefore, the protection scope of the present application shall be based on the protection scope of the claims.

What is claimed is:

1. A composite filtering device, comprising a tank with an open top (1), wherein a cover (2) is connected to an open top of the tank (1), a mixing cavity that communicates with an inner cavity of the tank (1) is provided in a lower end of the cover (2), the cover (2) is provided with a water inlet (3) and a water outlet (4) that communicate with the mixing cavity, a filter tube (5) that extends into the tank (1) and has its upper and lower ends communicating with each other is further provided at the lower end of the cover (2), the filter tube (5) is filled with a first filter medium, a second filter medium is contained in the tank (1), a lower end of the filter tube (5) extends into the second filter medium, and an upper end communicates with the water outlet (4).

2. The composite filtering device according to claim 1, wherein a first filter screen cover (7) is connected to the lower end of the filter tube (5), and a lower end of the first filter screen cover (7) is inserted and positioned at the bottom of the tank (1).

3. The composite filtering device according to claim 2, wherein a funnel-shaped first connector (8) is arranged at an upper end of a first filter screen cover, and a first positioning insertion tube (9) is arranged at an upper end of the first connector (8); and an inverted funnel-shaped second connector (10) that communicates with the water outlet (4) is connected to the lower end of the cover (2), a second positioning insertion tube (11) is arranged at a lower end of the second connector (10), and the upper end and the lower end of the filter tube (5) are detachably inserted and matched within the second positioning insertion tube (11) and the first positioning insertion tube (9) respectively.

4. The composite filtering device according to claim 3, wherein a second filter screen cover (12) accommodated within the tank (1) is connected to the lower end of the cover (2), an upper open top of the second filter screen cover (12) is connected to a lower open top of the mixing cavity, the bottom of the second filter screen cover (12) is provided with an insertion hole, and an upper end of the second connector (10) is inserted into the insertion hole.

5. The composite filtering device according to claim 1, wherein the first filter medium is filter cotton balls (6), and the second filter medium is filter sand; and a backwash inlet (13) that communicates with the mixing cavity is provided in a side wall of the cover (2), a valve assembly (14) for switching between a filter channel and a backwash channel is installed inside the mixing cavity, and when the valve assembly (14) is adjusted to place the backwash channel in communication with the mixing cavity, flushing water is able to enter the mixing cavity from the backwash inlet (13), pass through the filter tube (5), then enter the inner cavity of the tank (1), and finally flow out from the water inlet (3) to achieve backwashing of the second filter medium.

6. A composite filtering device, comprising a tank with an open top (1), wherein a cover (2) is connected to an open top of the tank (1), a mixing cavity that communicates with an inner cavity of the tank (1) is provided in a lower end of the cover (2), a water inlet (3) and a water outlet (4) that communicate with the mixing cavity are provided in the cover (2), a second filter medium is contained in the tank (1), a drainage pipe (21) is arranged in the tank (1), a lower end of the drainage pipe (21) extends into the second filter medium, and an upper end communicates with an inner end of the water outlet (4); a filter tube (5) is connected to an outer end of the water outlet (4), and the filter tube (5) is filled with a first filter medium.

7. The composite filtering device according to claim 6, wherein a first filter screen cover (7) is connected to the lower end of the drainage pipe (21), and a lower end of the first filter screen cover (7) is inserted and positioned at the bottom of the tank (1); and a second filter screen cover (12) accommodated within the tank (1) is connected to the lower end of the cover (2), an upper open top of the second filter screen cover (12) is connected to a lower open top of the mixing cavity, the bottom of the second filter screen cover (12) is provided with an insertion hole, and an upper end of the drainage pipe (21) is inserted into the insertion hole.

8. The composite filtering device according to claim 6, wherein the first filter medium is filter cotton balls (6), and the second filter medium is filter sand; a side wall of the cover (2) is further provided with a backwash inlet (13) that communicates with the mixing cavity, a valve assembly (14) for switching between a filter channel and a backwash channel is installed inside the mixing cavity, and when the valve assembly (14) is adjusted to place the backwash channel in communication with the mixing cavity, flushing water is able to enter the mixing cavity from the backwash inlet (13), pass through the drainage pipe (21), then enter the inner cavity of the tank (1), and finally flow out from the water inlet (3) to achieve backwashing of the second filter medium.
